(19) United States
(12) Patent Application Publication
(10) Pub. No.: US 2007/0005635 A1
(43) Pub. Date: Jan. 4, 2007

(54) Importing database data to a non-database program

(75) Inventors: Edward A. Martinez, Bellevue, WA (US); Tao Yue, Bellevue, WA (US); Ramanathan Pallassana, Sammamish, WA (US); Jan Jamrich, Bellevue, WA (US); Wan Li Zhu, Redmond, WA (US)

Correspondence Address: MARSHALL, GERSTEIN & BORUN LLP (MICROSOFT), 233 SOUTH WACKER DRIVE, 6300 SEARS TOWER, CHICAGO, IL, 60606, US

(73) Assignee: MICROSOFT CORPORATION, Redmond, WA (US)

(21) Appl. No.: 11/289,874

(22) Filed: Nov. 30, 2005

Related U.S. Application Data
(60) Provisional application No. 60/696,172, filed on Jul. 1, 2005.

(51) Int. Cl. G06F 7/00

(52) U.S. Cl. 707/102

(57) ABSTRACT

A method and system to implement the method of importing data to a non-database program is disclosed. The method may allow a user to identify data and formatting to be imported into a non-database program so that database data may be viewed in a non-database program.

This is a non-provisional of U.S. Provisional Application Ser. No. 60/696,172, filed Jul. 1, 2005, the entire disclosure of which is incorporated herein by reference.

### BACKGROUND

Database programs are useful to collect and sort data. For example, customer relationship management systems have enabled corporations to better track and analyze data on customers, suppliers, etc. However, other programs have improved abilities to display data in a more focused fashion and sometimes it is useful to view database data in other non-database programs.

### SUMMARY

A method and system to implement the method of importing data to a non-database program is disclosed. The method may allow a user to identify data and formatting to be imported into a non-database program so that database data may be viewed in a non-database program. The method may present an easy to user interface to a user but may perform the challenging steps of identifying the proper database, the proper file location and the proper SQL queries to obtain the data. These hard to obtain pieces of information may be passed to the non-database program, along with proper security and formatting, such that the data can be viewed and manipulated in a non-database program.

### DRAWINGS

FIG. 1 is a block diagram of a computing system that may operate in accordance with the claims;

FIG. 2 is flowchart of a method that may be in accordance with the claims;

FIG. 3 may illustrate a filtered data grid from a database in a database program such as a CRM program;

FIG. 4 may illustrate carrying over the same information that a user sees in the original database grid to a non-database program;

FIG. 5 may illustrate the resulting pivot table and chart;

FIG. 6 may illustrate an advanced find in a database program;

FIG. 7 may illustrate a response table to the search illustrated in FIG. 6;

FIG. 8 may illustrate a dialog to import data to a non-database program;

FIG. 9 may illustrate the selection of columns the user desires to be in the pivot table;

FIG. 10 may illustrate the launch of a non-database program;

FIG. 11 may illustrate the table that results after the user drags and drops the fields of interest; and

FIG. 12 may illustrate the ability to save this “live data” spreadsheet alongside other reports.

### DESCRIPTION

Although the following text sets forth a detailed description of numerous different embodiments, it should be understood that the legal scope of the description is defined by the words of the claims set forth at the end of this patent. The detailed description is to be construed as exemplary only and does not describe every possible embodiment since describing every possible embodiment would be impractical, if not impossible. Numerous alternative embodiments could be implemented, using either current technology or technology developed after the filing date of this patent, which would still fall within the scope of the claims.

It should also be understood that, unless a term is expressly defined in this patent using the sentence “As used herein, the term ‘______’ is hereby defined to mean . . . ” or a similar sentence, there is no intent to limit the meaning of that term, either expressly or by implication, beyond its plain or ordinary meaning, and such term should not be interpreted to be limited in scope based on any statement made in any section of this patent (other than the language of the claims). To the extent that any term recited in the claims at the end of this patent is referred to in this patent in a manner consistent with a single meaning, that is done for sake of clarity only so as to not confuse the reader, and it is not intended that such claim term by limited, by implication or otherwise, to that single meaning. Finally, unless a claim element is defined by reciting the word “means” and a function without the recital of any structure, it is not intended that the scope of any claim element be interpreted based on the application of 35 U.S.C. §112, sixth paragraph.

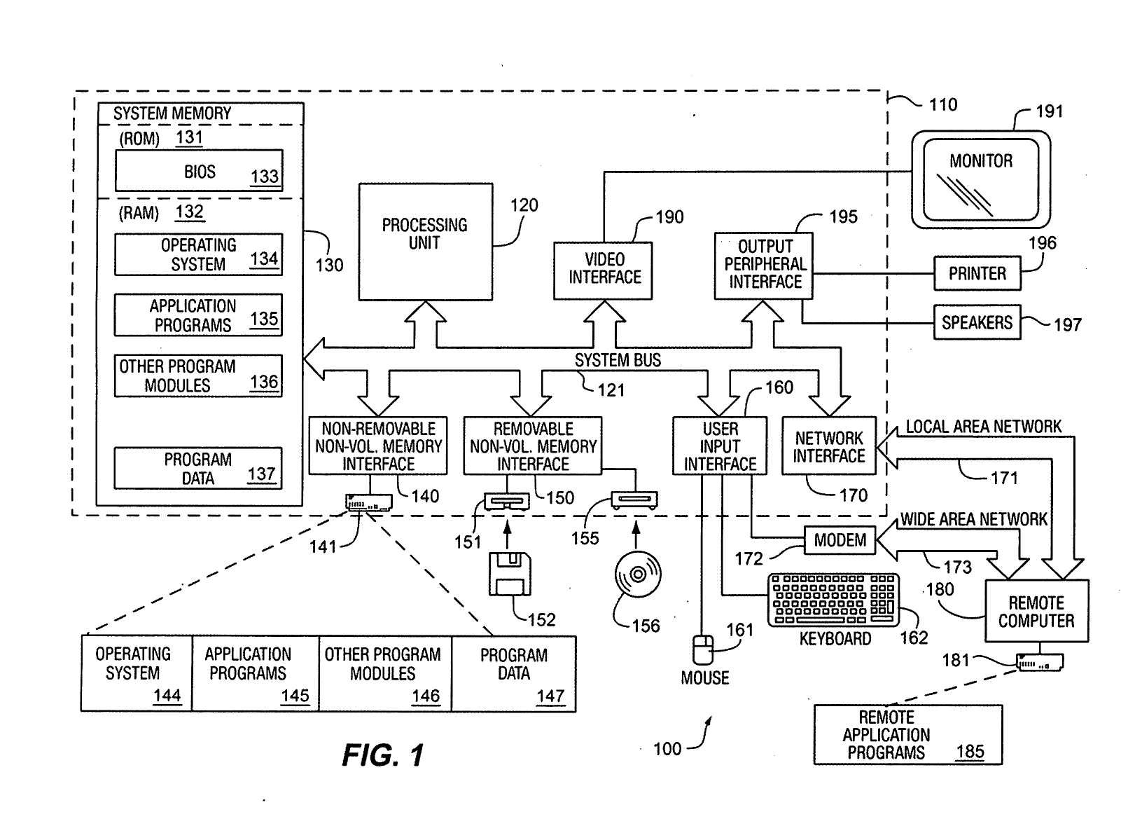

FIG. 1 illustrates an example of a suitable computing system environment 100 on which a system for the steps of the claimed method and apparatus may be implemented. The computing system environment 100 is only one example of a suitable computing environment and is not intended to suggest any limitation as to the scope of use or functionality of the method of apparatus of the claims. Neither should the computing environment 100 be interpreted as having any dependency or requirement relating to any one or combination of components illustrated in the exemplary operating environment 100.

The steps of the claimed method and apparatus are operational with numerous other general purpose or special purpose computing system environments or configurations. Examples of well known computing systems, environments, and/or configurations that may be suitable for use with the methods or apparatus of the claims include, but are not limited to, personal computers, server computers, hand-held or laptop devices, multiprocessor systems, microprocessor-based systems, set top boxes, programmable consumer electronics, network PCs, minicomputers, mainframe computers, distributed computing environments that include any of the above systems or devices, and the like.

The steps of the claimed method and apparatus may be described in the general context of computer-executable instructions, such as program modules, being executed by a computer. Generally, program modules include routines, programs, objects, components, data structures, etc. that perform particular tasks or implement particular abstract data types. The methods and apparatus may also be practiced in distributed computing environments where tasks are performed by remote processing devices that are linked through a communications network. In a distributed computing environment, program modules may be located in both local and remote computer storage media including memory storage devices.

With reference to FIG. 1, an exemplary system for implementing the steps of the claimed method and apparatus includes a general purpose computing device in the form of a computer 110. Components of computer 110 may include, but are not limited to, a processing unit 120, a system memory 130, and a system bus 121 that couples various system components including the system memory to the processing unit 120. The system bus 121 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

Computer 110 typically includes a variety of computer readable media. Computer readable media can be any available media that can be accessed by computer 110 and includes both volatile and nonvolatile media, removable and non-removable media. By way of example, and not limitation, computer readable media may comprise computer storage media and communication media. Computer storage media includes both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can accessed by computer 110. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer readable media.

The system memory 130 includes computer storage media in the form of volatile and/or nonvolatile memory such as read only memory (ROM) 131 and random access memory (RAM) 132. A basic input/output system 133 (BIOS), containing the basic routines that help to transfer information between elements within computer 110, such as during start-up, is typically stored in ROM 131. RAM 132 typically contains data and/or program modules that are immediately accessible to and/or presently being operated on by processing unit 120. By way of example, and not limitation, FIG. 1 illustrates operating system 134, application programs 135, other program modules 136, and program data 137.

The computer 110 may also include other removable/non-removable, volatile/nonvolatile computer storage media. By way of example only, FIG. 1 illustrates a hard disk drive 140 that reads from or writes to non-removable, nonvolatile magnetic media, a magnetic disk drive 151 that reads from or writes to a removable, nonvolatile magnetic disk 152, and an optical disk drive 155 that reads from or writes to a removable, nonvolatile optical disk 156 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 141 is typically connected to the system bus 121 through a non-removable memory interface such as interface 140, and magnetic disk drive 151 and optical disk drive 155 are typically connected to the system bus 121 by a removable memory interface, such as interface 150.

The drives and their associated computer storage media discussed above and illustrated in FIG. 1, provide storage of computer readable instructions, data structures, program modules and other data for the computer 110. in FIG. 1, for example, hard disk drive 141 is illustrated as storing operating system 144, application programs 145, other program modules 146, and program data 147. Note that these components can either be the same as or different from operating system 134, application programs 135, other program modules 136, and program data 137. Operating system 144, application programs 145, other program modules 146, and program data 147 are given different numbers here to illustrate that, at a minimum, they are different copies. A user may enter commands and information into the computer 20 through input devices such as a keyboard 162 and pointing device 161, commonly referred to as a mouse, trackball or touch pad. Other input devices (not shown) may include a microphone, joystick, game pad, satellite dish, scanner, or the like. These and other input devices are often connected to the processing unit 120 through a user input interface 160 that is coupled to the system bus, but may be connected by other interface and bus structures, such as a parallel port, game port or a universal serial bus (USB). A monitor 191 or other-type of display device is also connected to the system bus 121 via an interface, such as a video interface 190. In addition to the monitor, computers may also include other peripheral output devices such as speakers 197 and printer 196, which may be connected through an output peripheral interface 190.

The computer 110 may operate in a networked environment using logical connections to one or more remote computers, such as a remote computer 180. The remote computer 180 may be a personal computer, a server, a router, a network PC, a peer device or other common network node, and typically includes many or all of the elements described above relative to the computer 110, although only a memory storage device 181 has been illustrated in FIG. 1. The logical connections depicted in FIG. 1 include a local area network (LAN) 171 and a wide area network (WAN) 173, but may also include other networks. Such networking environments are commonplace in offices, enterprise-wide computer networks, intranets and the Internet.

When used in a LAN networking environment, the computer 110 is connected to the LAN 171 through a network interface or adapter 170. When used in a WAN networking environment, the computer 110 typically includes a modem 172 or other means for establishing communications over the WAN 173, such as the Internet. The modem 172, which may be internal or external, may be connected to the system bus 121 via the user input interface 160, or other appropriate mechanism. In a networked environment, program modules depicted relative to the computer 110, or portions thereof, may be stored in the remote memory storage device. By way of example, and not limitation, FIG. 1 illustrates remote application programs 185 as residing on memory device 181. It will be appreciated that the network connections shown are exemplary and other means of establishing a communications link between the computers may be used.

Traditional database programs may be useful at tracking data but may not provide the ability to drill down into data the way users may prefer. At times, it would be nice to see a limited amount of database data in a table. For example, a business user may wish to integrate Excel pivot tables with an existing database implementation, such as Microsoft CRM. However, the user may face a number of challenges that may frustrate and intimidate the users. For example, connection points to the data sources may be mysterious and so numerous in choice, that a user often times abandons trying to discover the proper combinations necessary to connect an application to a data source. In addition, SQL machine names and network paths may not be in the forefront of users' knowledge. Similarly, discoverability of database table connection points are difficult and documentation may not be intended for an end user audience. In addition, SQL, for all its strength and power, may be a mystery to most end users and requires a very technical orientation to exploit all of its potential. A strong business orientation and understanding the significance of underlying data should be the main emphasis required to evaluate and derive good business decisions.

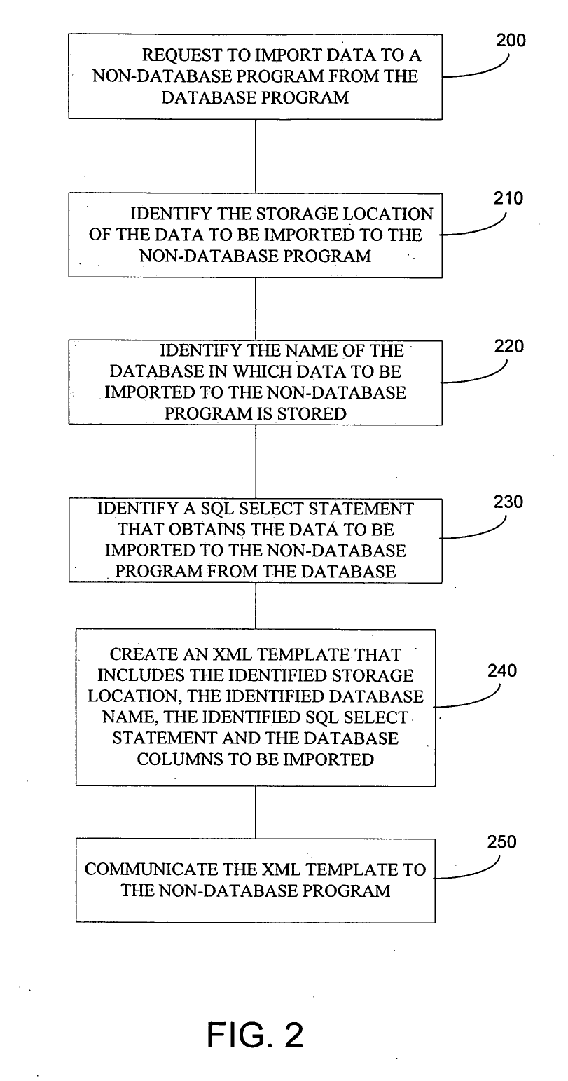

It would be nice to have a simple method to bridges the gap between obfuscated databases/servers and Excel pivot tables or other application features such as Word Mail Merge or PowerPoint Tables. FIG. 2 may be an illustration of a method of importing data to a non-database program from a database program in accordance with the claims.

At block 200, the method may request to import data to a non-database program from the database program. The request may be made in a variety of ways. For example, a user may select from a drop-down menu to import the data. In another example, the user may select a import button shortcut which may be on a menu bar. Certainly, other methods of requesting to import data are possible.

At block 210, the method may identify the storage location of the data to be imported to the non-database program. Modern database systems, such as CRM systems, attempt to keep relatively complex operating details out of the users mind. The system may replace long, complex, obscure or non-meaningful file location names with familiar or intuitive names which are more understandable to business user, such as “the Marshall Campaign”. In addition, the familiar name may be language independent so that it may be translated in several languages but may still refer to the same data in the same database. For example, a familiar file name of “Name and Address” may refer to the same data as “Nom et adresse.” Accordingly, the storage location may be identified for the user.

At block 220, the method may identify the name of the database in which data to be imported to the non-database program is stored. Somewhat similar to block 210, users of modern database systems do not desire to know the infinite details of file storage inside the database system. Instead of the file location name of “c:/files/users/wjk/misfiles/crm/campaigns/marshall.crm” user may be accustomed to simple names that have meaning such as “the June 2005 Marshall Campaign.” Accordingly, the database name may be identified for the user.

At block 230, the method may identify a SQL select statement that obtains the data to be imported to the non-database program from the database. Through a series of prompts or through a pop-up wizard, the user may be guided to select data to be imported to a non-database program such as a pivot table. Through the guiding process, users can easily select the data they desire to see in a different format. However, in order to obtain this data from a database, SQL statements are created by the system. SQL statement are well known by SQL programmers but not by CRM users, so the system creates the necessary SQL statements. In addition, the system may only obtain data to which the user has permission. For example, some data, such as a proprietary formula, may be so sensitive that only a few people in an organization may have access to this data. This data will be marked with this permission. The method may only be able to obtain data to which the user has rights.

At block 240, the method may create an XML template that includes the identified storage location, the identified database name, the identified SQL select statement and the database columns to be imported. XML is short for eXtensible Markup Language and is a file format that allows for easy transfer of data between various programs. Certainly, other file formats may be used. As part of the XML file, formatting selected by the user may be communicated to the non-database program, including grid layout information such as column width, sort order, etc. In addition, the system may go further and add other useful statements such as a statement to ensure that each time the non-database program opens the file, it reaches back to the database to obtain the most recent data, etc.

As an example, the Advanced find feature of Microsoft CRM provides an intuitive, user friendly and graphical method of constructing complex queries against the Microsoft CRM database. It may support selecting multiple columns, specifying sort order, grouping of conditions and cross entity joins. The advanced find feature may be driven by the Metadata information available in Microsoft CRM. The Metadata provides information about the Entities, Attributes and Relationships between entities. This metadata is dynamic in that, when the user customizes the system to add new entities, attributes or relationships they are reflected in the Metadata. Advanced find converts the query that the user creates using the graphical interface into a XML representation. It may use the Metadata to convert the user friendly display names of Entities, Attributes and Relationships into logical names that is understood by the Microsoft CRM Query execution engine. It also may use Metadata to convert user-friendly picklist and lookup values to codes that are understood by the query engine. The generated XML may be known as the Fetch XML and may be consumed by the Microsoft CRM Query engine. The query engine may convert the Fetch XML into SQL making use of Metadata information.

At block 250, the method may communicate the XML template to the non-database program. The non-database program may then display the data in a format and layout defined by the XML template. At this point, the data displayed in the non-database program may be edited without affecting the underlying data in the database.

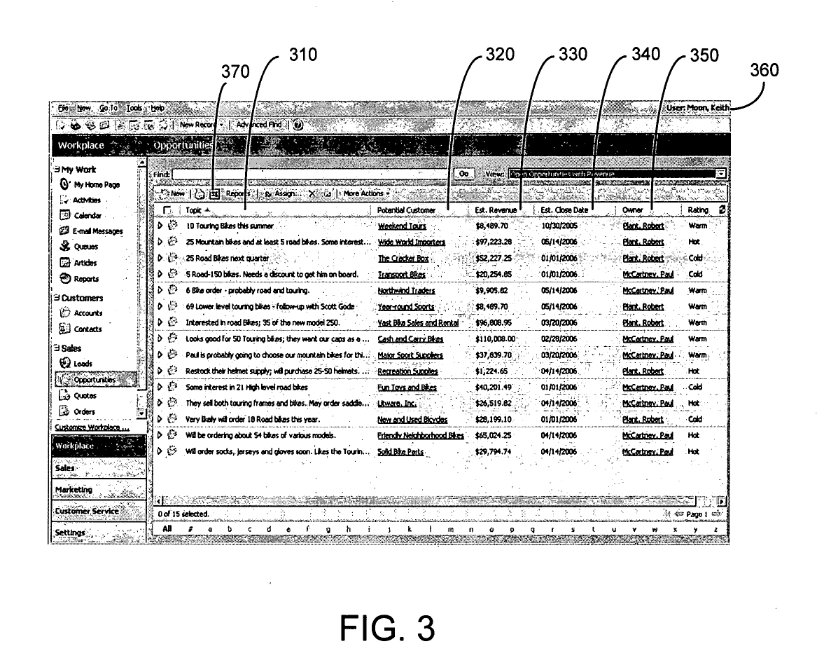

As an example of the system in operation, FIG. 3 may illustrate a filtered data grid from a database in a database program such as a CRM program. The grid may have columns such as topic 310, potential customer 320, estimated revenue 330, estimated close date 340, and owner 350. The grid may also indicate the current user of the database 360 and each user may have a given permission to see some data and not other data depending on the level of permission. The grid may also have a button to create a non-database program report 370.

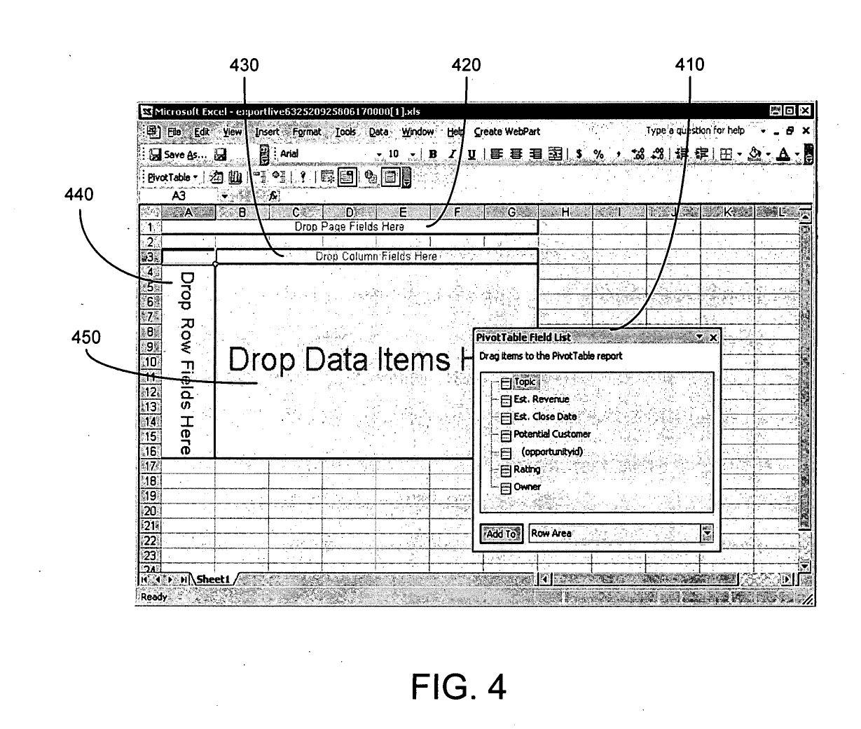

FIG. 4 may illustrate carrying over the same information that a user sees in the original database grid to an Excel pivot table (a non-database program). This may occur by clicking on the Excel icon on the grid toolbar (370 in FIG. 3). FIG. 4 also may illustrate options presented to a user in creating the pivot table. The number of items on “field list” 410 may be reduced to (but not limited to) the field of view of the data the user originally had. By design, this may allow users to focus and concentrate on the important, without being inundated with too many fields to sort through. In addition, the user is presented the opportunity to drag and drop page fields 420, colunm fields 430, row fields 440 and data items 450.

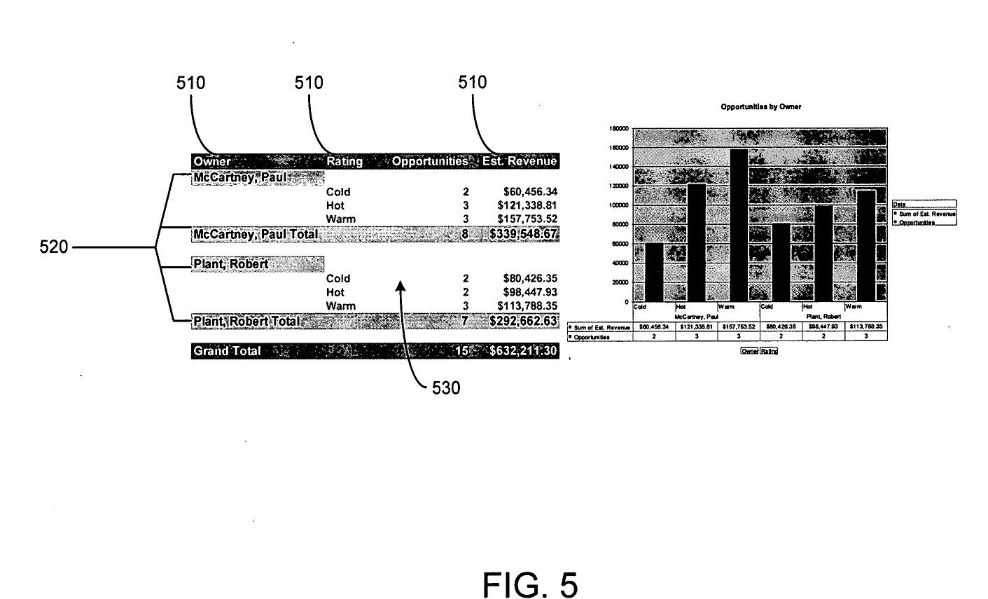

FIG. 5 may illustrate the resulting pivot table and chart. The original data is now in a much more understandable form. The selected columns 510 are displayed, as are the selected rows 520 and the selected data 530. The user may now save this spreadsheet to CRM as a report and then load it later with updated values or may use the contents in WebParts to display in a corporate Sharepoint site, with the added assurance that individual security is properly applied to data being presented.

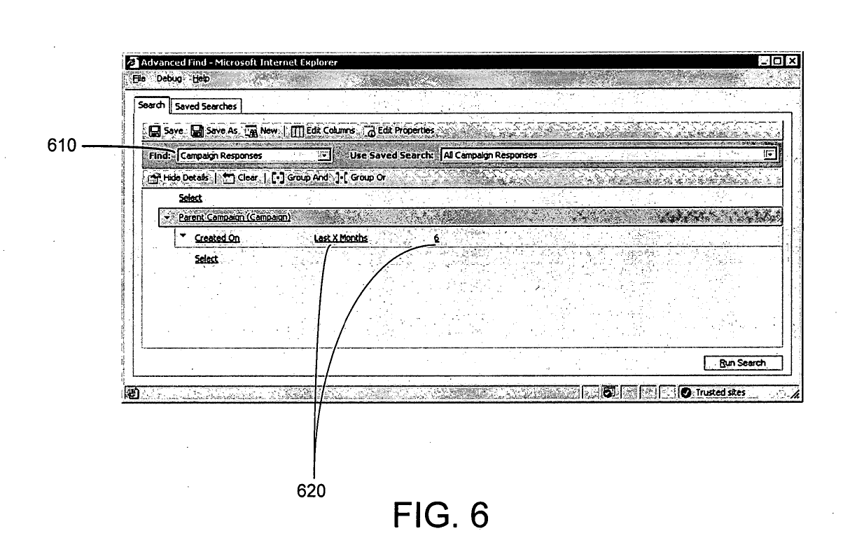

FIG. 6 may illustrate an advanced find which allows business users the ability to pose questions such as “How effective have my recent marketing campaigns been?” or “How well balanced is the response team distributed among my sales force?” in a structured query environment. Specifically, the question may request the database to return all the Campaign Reponses 610 for the most recent (6 months) 620 marketing campaigns.

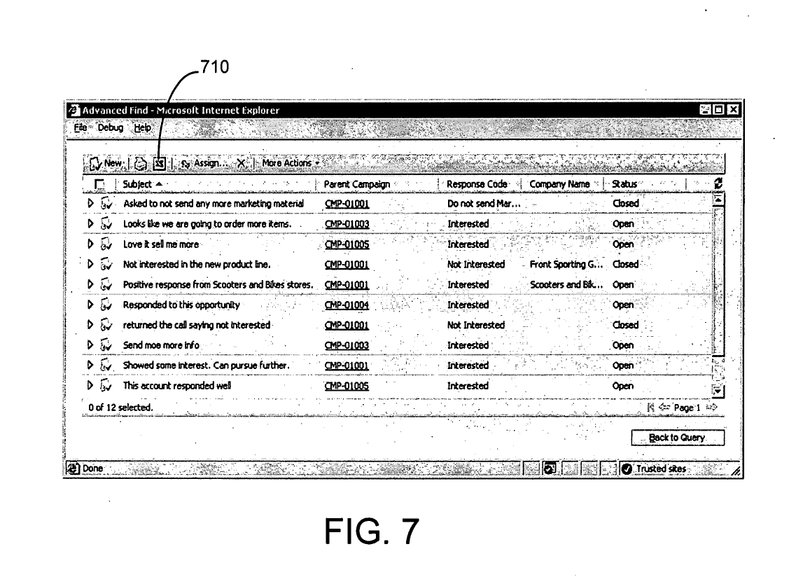

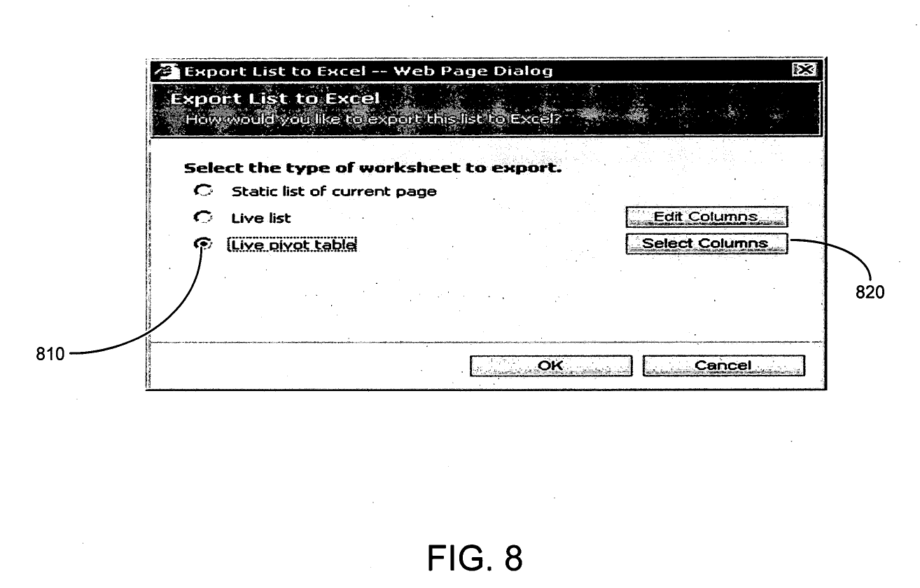

FIG. 7 may illustrate a response table to the search illustrated in FIG. 6. Now that the desired data has been retrieved, the user may like to be able to see this data in a pivot table and chart as it is difficult to quickly see the counts and assignments in this view. Additionally, the user may want to take into account the “Response Code” of the campaign. The method may begin by clicking on a button such as the Excel button 710. FIG. 8 may illustrate a dialog after the Excel button has been selected where a user can select to see a pivot table 810 and select columns for the table 820.

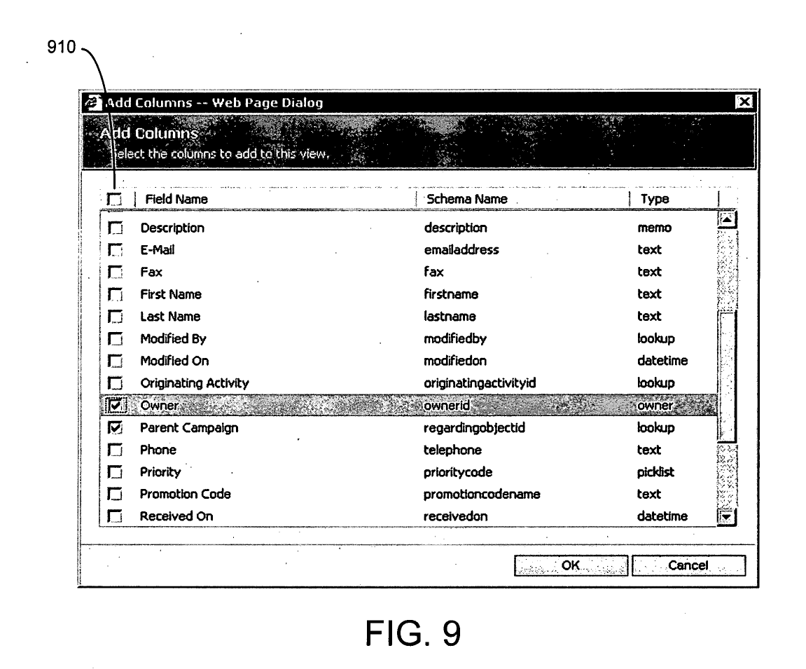

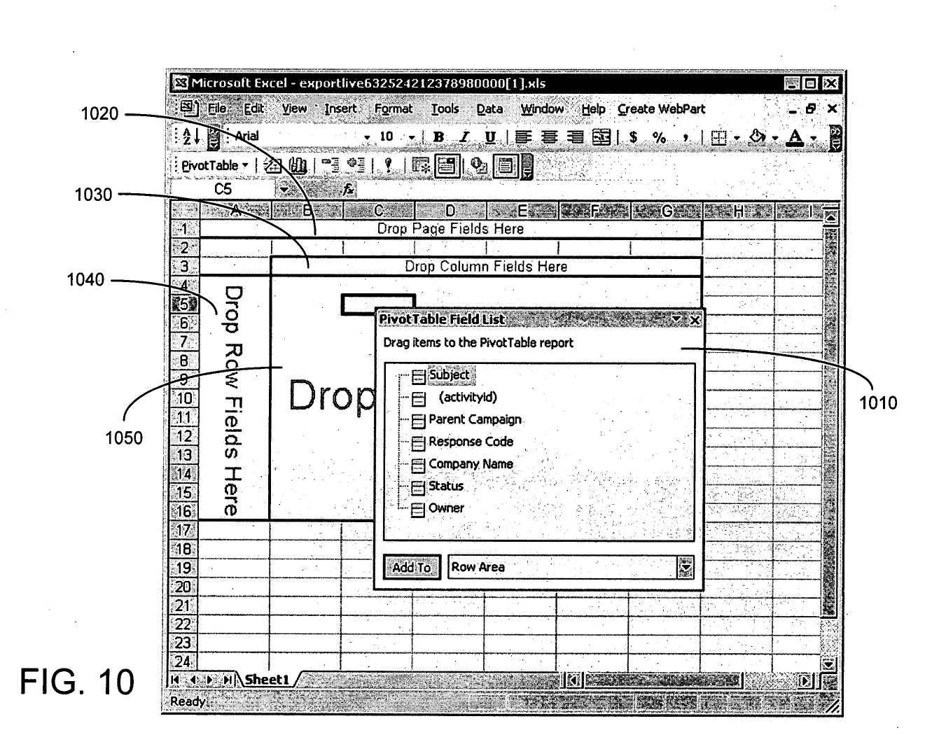

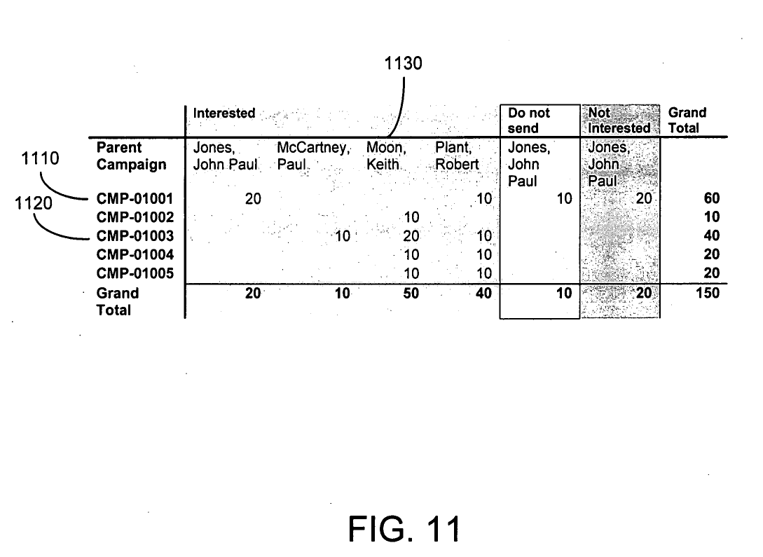

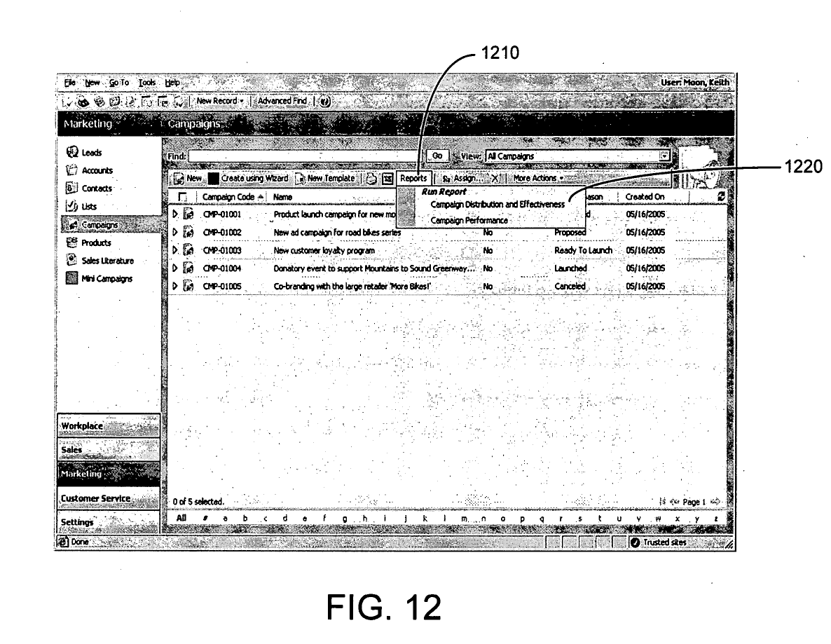

FIG. 9 may illustrate the selection of columns 910 the user desires to be in the pivot table. FIG. 10 may illustrate the launch of Excel and the pivot table creation. As explained in regard to FIG. 4, the number of items on “field list” 1010 may be reduced to (but not limited to) the field of view of the data the user originally had. In addition, the user is presented the opportunity to drag and drop page fields 1020, column fields 1030, row fields 1040 and data items 1050. FIG. 11 may illustrate the table that results after the user drags and drops the fields of interest. The table makes it clear that campaign CMP-01001 (1110) and CMP-01003 (1120) had the most responses and the distribution of the campaigns is a skewed towards Keith Moon (1130). FIG. 12 may illustrate the ability to save this “live data” report spreadsheet alongside other reports and may be accessed straight from a campaign area in CRM 1210. The spreadsheet may have a descriptive title such as “Campaign Distribution and Effectiveness” 1220 and it may be published it in CRM associating it to the Campaigns area.

Although the forgoing text sets forth a detailed description of numerous different embodiments, it should be understood that the scope of the patent is defined by the words of the claims set forth at the end of this patent. The detailed description is to be construed as exemplary only and does not describe every possible embodiment because describing every possible embodiment would be impractical, if not impossible. Numerous alternative embodiments could be implemented, using either current technology or technology developed after the filing date of this patent, which would still fall within the scope of the claims.

Thus, many modifications and variations may be made in the techniques and structures described and illustrated herein without departing from the spirit and scope of the present claims. Accordingly, it should be understood that the methods and apparatus described herein are illustrative only and are not limiting upon the scope of the claims.

1. A method of importing data to a non-database program from a database program comprising:
requesting to import data to a non-database program from the database program;
identifying the storage location of the data to be imported to the non-database program;
identifying the name of the database in which data to be imported to the non-database program is stored;
identifying a SQL select statement that obtains the data to be imported to the non-database program from the database;
creating an XML template that includes the identified storage location, the identified database name, the identified SQL select statement and the database columns to be imported; and
communicating the XML template to the non-database program.

2. The method according to claim 1, wherein the SQL select statement only returns data to which the requestor has permission.

3. The method according to claim 1, further comprising displaying the requested data in a non-database program.

4. The method according to claim 1, further comprising allowing formatting information from the non-database program to be added to the XML template.

5. The method according to claim 1, further comprising allowing the data displayed in the non-database program to be edited without affecting the underlying data in the database.

6. The method according to claim 1, further comprising adding additional statements to the XML template to ensure the data from the database is the most recent data.

7. A computer-readable medium having computer-executable modules for execution on a computer comprising:
requesting to import data to a non-database program from the database program;
identifying the storage location of the data to be imported to the non-database program;
identifying the name of the database in which data to be imported to the non-database program is stored;
identifying a SQL select statement that obtains the data to be imported to the non-database program from the database wherein the SQL select statement only returns data to which the requestor has permission;
creating an XML template that includes the identified storage location, the identified database name, the identified SQL select statement and the database columns to be imported;
communicating the XML template to the non-database program; and
displaying the requested data in a non-database program.

8. The computer readable medium of claim 7, flurther comprising allowing formatting information from the non-database program to be added to the XML template.

9. The computer readable medium of claim 7, fuirther comprising allowing the data displayed in the non-database program to be edited without affecting the underlying data in the database.

10. The computer readable medium of claim 7, further comprising adding additional statements to the XML template to ensure the data from the database is the most recent data.

11. A computer comprising:
a processing unit for executing instructions;
a networking device coupled to processing unit for coupling data transmitted between the computer and a network;
a memory for storing computer executable instructions, coupled to the processing unit, the computer executable instructions for executing a method comprising:
requesting to import data to a non-database program from the database program;
identifying the storage location of the data to be imported to the non-database program;
identifying the name of the database in which data to be imported to the non-database program is stored;
identifying a SQL select statement that obtains the data to be imported to the non-database program from the database wherein the SQL select statement only returns data to which the requestor has permission;
creating an XML template that includes the identified storage location, the identified database name, the identified SQL select statement and the database columns to be imported;
allowing formatting information from the non-database program to be added to the XML template;
communicating the XML template to the non-database program; and
displaying the requested data in a non-database program.

12. The computer of claim 11, further comprising computer executable instructions for allowing the data displayed in the non-database program to be edited without affecting the underlying data in the database.

13. The computer of claim 11, further comprising computer executable instructions for adding additional statements to the XML template to ensure the data from the database is the most recent data.
